(19) United States
(12) Patent Application Publication
(10) Pub. No.: US 2024/0347845 A1
(43) Pub. Date: Oct. 17, 2024

(54) BATTERY MODULE ASSEMBLY

(71) Applicants: HYUNDAI MOTOR COMPANY, Seoul (KR); KIA CORPORATION, Seoul (KR)

(72) Inventor: Kyung Mo Kim, Hwaseong-si (KR)

(21) Appl. No.: 18/368,763

(22) Filed: Sep. 15, 2023

(30) Foreign Application Priority Data
Apr. 17, 2023 (KR) 10-2023-0050092

(51) Int. Cl. H01M 50/291; H01M 50/207; H01M 50/505

(52) U.S. Cl. CPC H01M 50/291; H01M 50/207; H01M 50/505

(57) ABSTRACT

A battery module assembly includes a plurality of battery cells, a first plate which is provided between the battery cells and groups the battery cells and on which a protruding joint part is formed, a second plate provided on an outer side of an outermost battery cell and configured to cover a side portion of the battery cell, and a top cover which covers an upper portion of the battery cell and includes an upper clamp coupled to the joint part of the first plate.

### CROSS REFERENCE TO RELATED APPLICATIONS

The present application claims priority of Korean Patent Application No. 10-2023-0050092 filed on Apr. 17, 2023, the entire contents of which is incorporated herein for all purposes by this reference.

### BACKGROUND

### Field

The present disclosure relates to a battery module assembly.

### Description of the Related Art

A battery installed as an energy source for an electric vehicle is formed of a set of battery cells forming a smallest unit. Specifically, battery cells are aggregated to form a battery module, and battery modules are aggregated to form a battery pack. An additional battery management system (BMS), a device for cooling the battery, and the like are added to the battery pack.

The battery among parts of the electric vehicle occupies a lot of weight and volume and is a factor that greatly affects driving performance. That is, as the weight of the battery increases, energy that can be stored increases, but as the weight of the vehicle increases, electrical efficiency does not increase dramatically.

However, when components that can be removed from the battery are removed and a structural change is made to supplement the role of the removed components, energy efficiency increases because the weight is reduced compared to the same capacity.

Thus, reduction of the overall weight of the battery while maintaining or increasing the capacity of the battery is a key challenge in the industry.

The foregoing is intended merely to aid in understanding of the background of the present disclosure and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to propose a battery module assembly capable of maintaining a mechanical characteristic while minimizing unnecessary parts

According to one aspect, there is provided a battery module assembly including a plurality of battery cells, a first plate which is provided between the battery cells and groups the battery cells and on which a protruding joint part is formed, a second plate provided on an outer side of an outermost battery cell and configured to cover a side portion of the battery cell, and a top cover which covers an upper portion of the battery cell and includes an upper clamp coupled to the joint part of the first plate.

The joint part may protrude from one point of the first plate to surround a portion of the battery cell.

The upper clamp may include a first upper coupling part coupled to the joint part and a second upper coupling part coupled to the second plate.

The battery module assembly may further include a lower clamp coupled to the joint part of the first plate.

The lower clamp may include a first lower coupling part coupled to the joint part and a second lower coupling part coupled to the second plate.

The joint part may be formed as a plurality of joint parts in the center of the first plate.

The joint part may be formed at an upper end or a lower end of the first plate, and adjacent joint parts may be formed in different directions.

The battery module assembly may further include a bus bar configured to electrically connect adjacent battery cells.

The bus bar may electrically connect battery cells with the first plate interposed therebetween.

### BRIEF DESCRIPTION OF THE FIGURES

The above and other objects, features and other advantages of the present disclosure will be more clearly understood from the following detailed description when taken in conjunction with the accompanying drawings, in which:

FIG. 1 is a diagram illustrating a battery module assembly according to one embodiment of the present disclosure;

FIG. 2 is an exploded view illustrating the battery module assembly according to one embodiment of the present disclosure;

FIG. 3 is a diagram illustrating a battery module assembly according to the related art;

FIG. 4 is an exploded view illustrating the battery module assembly according to the related art;

FIG. 5 is a diagram illustrating a plate of the battery module assembly according to the related art;

FIG. 6 is a diagram illustrating first and second plates of the battery module assembly according to one embodiment of the present disclosure;

FIG. 7 is a diagram illustrating the first plate according to one embodiment of the present disclosure;

FIG. 8 is a diagram illustrating a state in which an upper clamp of a top cover is coupled to the first plate; and

FIG. 9 is a diagram illustrating a bus bar of the battery module assembly according to one embodiment of the present disclosure.

### DETAILED DESCRIPTION

Hereinafter, embodiments disclosed in the present specification will be described in detail with reference to the drawings. The same reference numerals are given to the same or similar components regardless of reference numerals, and a repetitive description thereof will be omitted.

In the following description of the present specification, when a detailed description of a known related art is determined to obscure the gist of the present specification, the detailed description thereof will be omitted herein. In addition, the accompanying drawings are merely for easy understanding of the embodiments disclosed in the present specification, the technical spirit disclosed in the present specification is not limited by the accompanying drawings, and it should be understood to include all modifications, equivalents, and substitutes included in the spirit and scope of the present disclosure.

Terms including ordinal numbers such as first, second, and the like used herein may be used to describe various components, but the various components are not limited by these terms. The terms are used only for the purpose of distinguishing one component from another component.

Unless the context clearly dictates otherwise, the singular form includes the plural form.

In the present specification, the terms “comprising,” “having,” or the like are used to specify that a feature, a number, a step, an operation, a component, an element, or a combination thereof described herein exists, and they do not preclude the presence or addition of one or more other features, numbers, steps, operations, components, elements, or combinations thereof.

As used herein, suffixes “module” and “part” for a component of the present disclosure are used or interchangeably used solely for ease of preparation of the specification, and do not have different meanings and each of them does not function by itself.

When a component is referred to as being “connected,” or “coupled” to another component, it may be directly connected or coupled to another component, but it should be understood that yet another component may be present between the component and another component. On the contrary, when a component is referred to as being “directly connected” or “directly coupled” to another component, it should be understood that still another component may not be present between the component and another component.

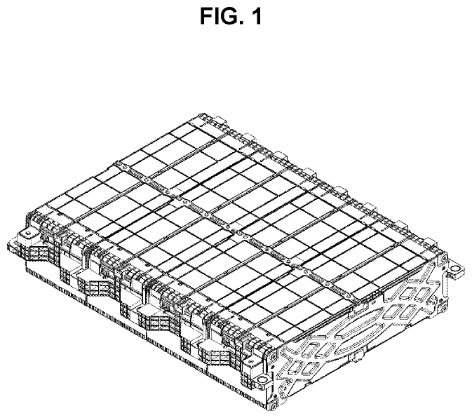

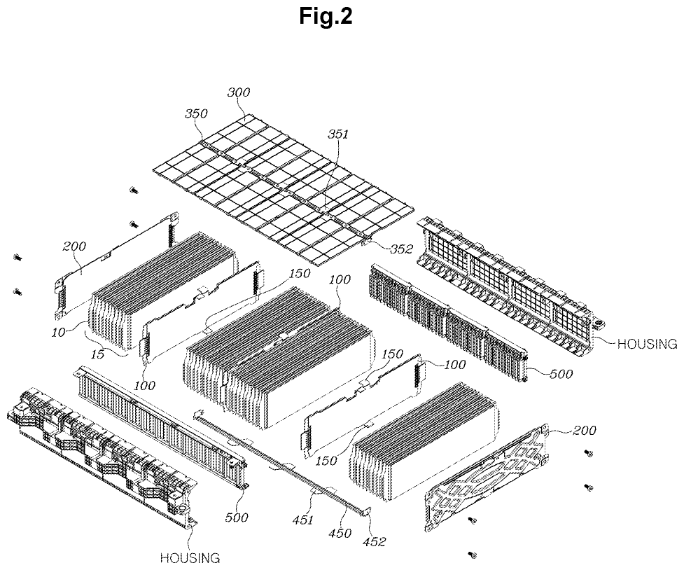

FIG. 1 is a diagram illustrating a battery module assembly according to one embodiment of the present disclosure, and FIG. 2 is an exploded view illustrating the battery module assembly according to one embodiment of the present disclosure.

In a battery built into an electric vehicle, a battery module is formed through a set of battery cells, and a battery pack is formed through a set of battery modules.

Referring to FIGS. 1 and 2, in the battery module assembly, a plurality of battery cells 10 are stacked to form battery cell bundles 15, and first plates 100 are provided between some of the battery cell bundles 15 to group the plurality of battery cells 10. That is, the first plates 100 are provided between the battery cell bundles 15 to group the plurality of battery cells 10.

A second plate 200 is a component provided on an outer side of an outermost battery cell 10 and configured to cover and protect the outermost battery cell 10 from internal and external forces and may be provided as two or more second plates in one module of the battery cells 10.

The battery cells 10 are provided between the first plates 100 or the second plates 200, and the first plate 100 and the second plate 200 serve to protect the battery cells 10.

In addition, the first plate 100 or the second plate 200 may align the stacked battery cells 10, restrain the aligned state to allow leads of the stacked battery cells 10 to be welded to a bus bar 500, which will be described below, and may be coupled to an upper clamp 350 or a lower clamp 450, which will be described below, to strengthen the restraint of the battery cell bundles 15 to be robust.

Meanwhile, the number of the battery cells 10 provided between the first plate 100 and the second plate 200 is generally the same, and the same number of the battery cells 10 constituting the battery cell bundle 15 are shown in the drawing, but the number of the battery cells 10 may vary in some cases.

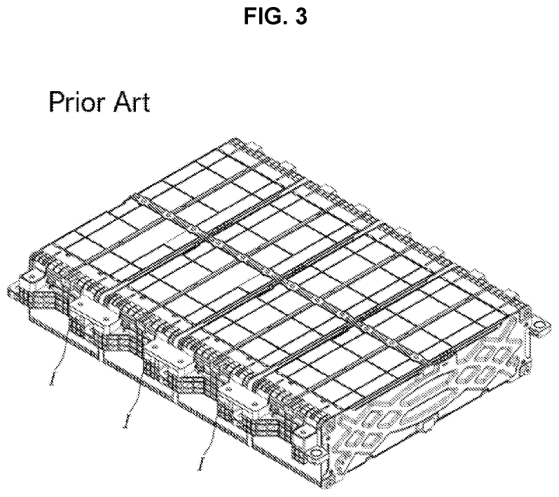

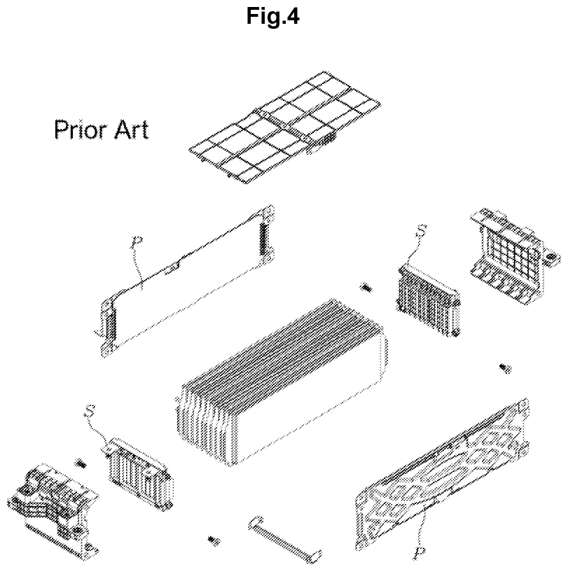

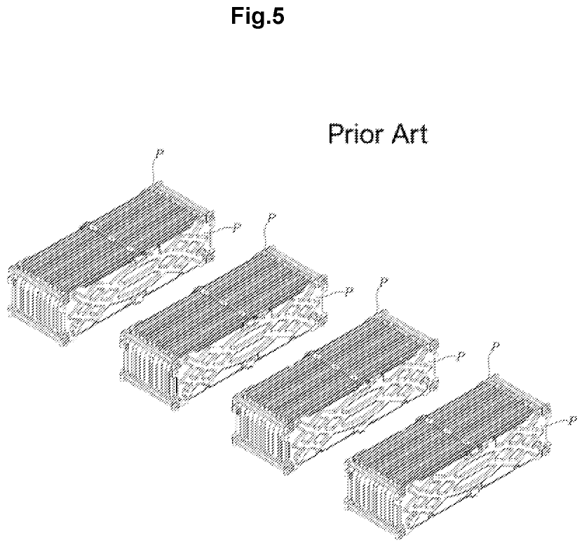

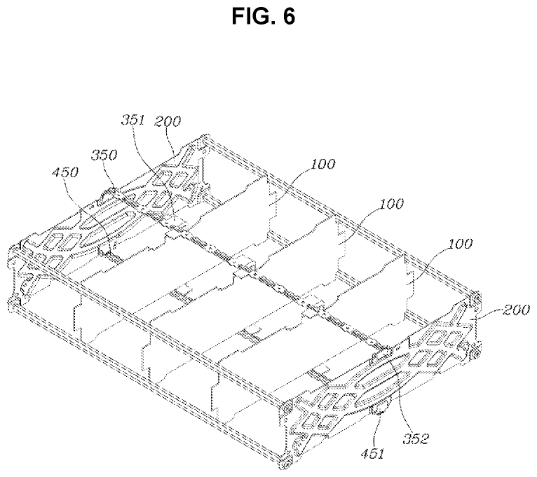

Meanwhile, FIG. 3 is a diagram illustrating a battery module assembly according to the related art, FIG. 4 is an exploded view illustrating the battery module assembly according to the related art, FIG. 5 is a diagram illustrating a plate of the battery module assembly according to the related art, and FIG. 6 is a diagram illustrating first and second plates of the battery module assembly according to one embodiment of the present disclosure.

Referring to FIGS. 3 to 6, according to both the related art and the present disclosure, the battery cell bundle is positioned between plates. However, it can be seen that a plate P-battery cell bundle-plate constitutes one module in the related art, whereas, the second plate 200-battery cell bundle 15-first plate 100-battery cell bundle 15-first plate 100-battery cell bundle 15-first plate 100-battery cell bundle 15-second plate 200 forms one module in the present disclosure.

However, the number of battery cell bundles constituting the module is only an example, and the present disclosure is not limited thereto.

That is, the present disclosure includes more battery cell bundles 15 in one module, thereby including more battery cells 10 in one module compared to the related art. Therefore, it can be seen that, even when the same number of battery cells 10 are included in the present disclosure as that in the related art, the number of plates used per battery module is reduced.

That is, according to the present disclosure, there is an advantage capable of reducing the number of plates used per battery module compared to the related art to reduce the overall weight of the battery pack and increasing an amount of energy per unit volume due to the reduction of the number of plates.

Meanwhile, batteries built into electric vehicles are mainly lithium-ion batteries. In the case of the lithium ion battery, a swelling phenomenon, in which the battery cell swells due to a gas generation inside the battery cell, such as vaporization of an electrolyte inside the battery cell due to an internal additional chemical reaction during battery charging or discharging, may occur.

In this case, due to the occurrence of the swelling phenomenon of the battery cell, when an external force is applied to the plate in contact with the battery cell, mechanical distortion may occur.

Thus, as shown in FIGS. 3 and 4, in the battery module assembly according to the related art, the plate P is placed on an outermost part of the battery cell to absorb a swelling reaction force, thereby preventing mechanical distortion from occurring.

When compared to the related art, the number of plates absorbing the reaction force due to the swelling of the battery cell is small in the present disclosure, but even when the number of plates is reduced by a structure which will be described below, a mechanical characteristic such as bending rigidity of the plate in a plane direction is not inferior to that of the related art.

Referring again to FIG. 2, a protruding joint part 150 is formed at one point of the first plate 100. The joint part 150 is a component for coupling a top cover 300, which covers an upper portion of the battery cell 10 to prevent an inflow of foreign materials, to the first plate 100 and strengthening the restraint of the battery cell 10 of the first plate 100. The top cover 300 includes the upper clamp 350, and the upper clamp 350 is coupled to the joint part 150.

Here, the coupling may mean laser welding, and the joint part 150 and the upper clamp 350 may each be made of a material to which the laser welding is applicable.

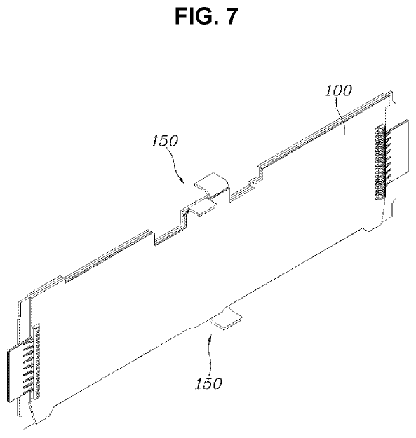

Meanwhile, FIG. 7 is a diagram illustrating the first plate 100 according to one embodiment of the present disclosure. Referring to FIG. 7, joint parts 150 protrude from center of the first plate 100 in upper and lower portions of the first plate 100 to surround a portion of the battery cell 10.

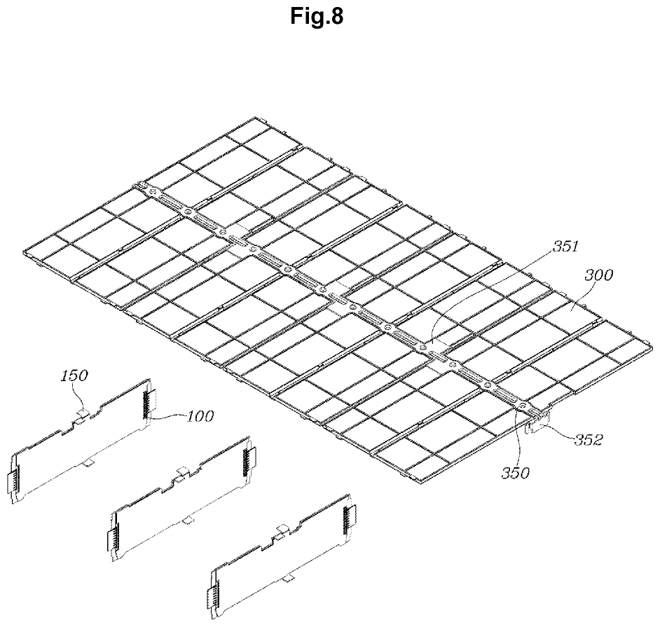

Referring to FIG. 8, it can be seen that the upper clamp 350 is coupled to the joint part 150 of the first plate 100. The joint part 150 is coupled to a first upper coupling part 351 of the upper clamp 350.

By considering the swelling reaction force of the battery cell, a plurality of joint parts 150 may be formed in the center of the first plate 100 to be coupled to the first upper coupling part 351 of the upper clamp 350. When the upper clamp 350 and the first plate 100 are coupled at many points, since a structure for withstanding the swelling reaction force of the battery cell becomes robust, it is preferable that two or more joint parts 150 are formed.

In addition, the joint part 150 may be formed on an upper end or a lower end of the first plate 100. That is, a plurality of joint parts 150 are formed at the lower end and coupled to a first lower coupling part 451 of the lower clamp 450 at the lower portion so that the rigidity of the battery module assembly can be further strengthened.

In addition, it is preferable that adjacent joint parts 150 are formed in different directions. This is because it is a structure suitable for withstanding the swelling reaction force of the battery cell when the adjacent joint parts 150 are facing in different directions compared to when the adjacent joint parts 150 are facing in the same direction.

Meanwhile, the second plate 200 is provided in an outward direction of the battery cell 10 positioned at the outermost side. An upper end of the second plate 200 may be coupled to a second upper coupling part 352 of the upper clamp 350, and a lower end thereof may be coupled to a second lower coupling part 452 of the lower clamp 450.

Through the coupling of the above-described components, a large number of the battery cells 10 can be included in one battery module, and the weight and dead space of the battery module can be reduced.

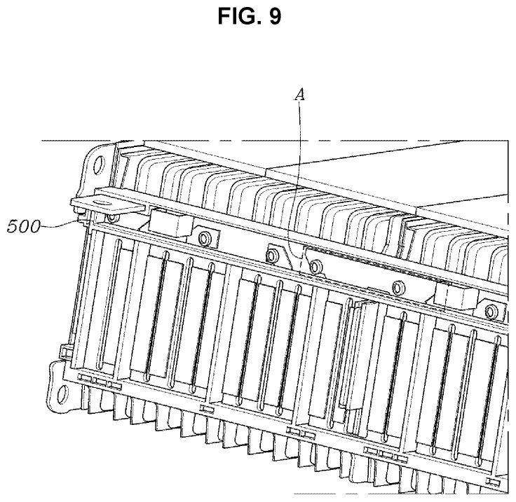

As shown in FIG. 9, the battery module assembly according to one embodiment of the present disclosure may further include the bus bar 500 for electrically connecting adjacent battery cells 10 to each other. The bus bar 500 of the present disclosure may electrically connect the battery cell bundles 15 with the first plate 100 interposed therebetween as well as the adjacent battery cells 10.

Specifically, referring to FIGS. 3 and 4, according to the related art, a sensing block S is provided to electrically connect the battery cells, and an inter bus bar I is required to be provided to electrically connect the sensing blocks S of modules again.

On the other hand, referring to FIG. 9, through a structure A for electrically connecting the battery cell bundles while electrically connecting the battery cells 10, the bus bar 500 of the present disclosure may electrically connect the battery cell bundles 15 so that there is an advantage capable of omitting the inter bus bar I required in the related art and thus reducing the weight of the battery module.

In accordance with a battery module assembly of the present disclosure, even when a large number of battery cells are formed as one module, it is possible to prevent degradation in rigidity of a large-area module, to reduce a battery weight by minimizing unnecessary parts due to the large-area module, to minimize a dead space.

Although specific embodiments of the present disclosure has been described and illustrated, those skilled in the art will appreciate that various alternations and modifications are possible without departing from the technical spirit of the present disclosure as disclosed in the appended claims.

1. A battery module assembly, comprising:
a plurality of battery cells;
a first plate positioned between a group of the plurality of battery cells, the first plate having a protruding joint part;
a second plate provided on an outer side of an outermost battery cell of the plurality of battery cells, and configured to cover a side portion of the outermost battery cell; and
a top cover configured to cover an upper portion of each of the plurality of battery cells, the top cover including an upper clamp coupled to the protruding joint part of the first plate.

2. The battery module assembly of claim 1, wherein the protruding joint part protrudes from one point of the first plate to surround a portion of the plurality of battery cells.

3. The battery module assembly of claim 1, wherein the upper clamp includes a first upper coupling part coupled to the protruding joint part, and a second upper coupling part coupled to the second plate.

4. The battery module assembly of claim 1, further comprising:
a lower clamp coupled to the protruding joint part of the first plate.

5. The battery module assembly of claim 4, wherein the lower clamp includes a first lower coupling part coupled to the protruding joint part and a second lower coupling part coupled to the second plate.

6. The battery module assembly of claim 1, wherein the protruding joint part is formed as a plurality of protruding joint parts in a center of the first plate.

7. The battery module assembly of claim 6, wherein the protruding joint part is formed at an upper end or a lower end of the first plate, and adjacent protruding joint parts are formed in different directions.

8. The battery module assembly of claim 1, further comprising:
a bus bar configured to electrically connect adjacent battery cells of the plurality of battery cells.

9. The battery module assembly of claim 8, wherein the bus bar electrically connects the plurality of battery cells with the first plate positioned between the group of the plurality of battery cells.
